(19) United States
(12) Patent Application Publication
(10) Pub. No.: US 2019/0070571 A1
(43) Pub. Date: Mar. 7, 2019

(54) FLUID MIXER

(71) Applicant: Waters Technologies Corporation, Milford, MA (US)

(72) Inventors: Michael R. Jackson, Woonsocket, RI (US); Peter MacKinnon, Providence, RI (US)

(21) Appl. No.: 16/111,699

(22) Filed: Aug. 24, 2018

Related U.S. Application Data
(60) Provisional application No. 62/554,803, filed on Sep. 6, 2017.

(51) Int. Cl. B01F 5/06; B01F 3/08; B01D 15/16

(52) U.S. Cl. CPC B01F 5/0644; B01F 3/0861; B01F 2215/0037; B01D 15/166; B01F 5/0645

(57) ABSTRACT

A fluid mixer includes a flow splitter, a plurality of channels and a mixing chamber. The flow splitter includes an inlet for receiving a flow of fluid and is configured to split the flow of fluid into a plurality of fluid streams. Each channel conveys a corresponding one of the fluid streams. The channels have dissimilar volumes and a substantially identical pressure drop across the length of each channel. The mixing chamber includes a plurality of inlets. Each of the inlets of the mixing chamber is connected to a corresponding one of the channels.

### RELATED APPLICATIONS

This application claims the benefit of and priority to co-pending U.S. provisional application No. 62/554,803, filed Sep. 6, 2017, titled “FLUID MIXER” the entirety of which is incorporated by reference herein.

### FIELD OF THE INVENTION

The invention relates generally to fluid mixers. More specifically, the invention relates to multi-path fluid mixers for use in microfluidic separation systems to mix solvent compositions.

### BACKGROUND

Chromatography is a set of techniques for separating a mixture into its constituents. Generally, in a liquid chromatography analysis, a pump takes in and delivers a composition of liquid solvents at high pressure to a sample manager, where a sample (i.e., material under analysis) awaits injection into the mixture. Disposed between the pump and sample manager, a mixer blends the liquid solvents into a substantially homogenous composition. From the sample manager, the resulting composition comprised of the mixture of liquid solvents and injected sample moves to a point of use, such as a column of particulate matter. By passing the composition through the column, the various components in the sample separate from each other at different rates and thus elute from the column at different times. A detector receives the elution from the column and produces an output from which the identity and quantity of the analytes may be determined.

High-performance liquid chromatography (HPLC) uses two basic elution modes: isocratic elution and gradient elution. In the isocratic elution mode, the mobile phase, comprised of either a pure solvent or a mixture of solvents, remains the same throughout the chromatography run. In the gradient elution mode, the composition of the mobile phase changes during the separation. Creation of the gradient involves the mixing of multiple solvents, the proportions of which change over time in accordance with a predetermined timetable. Some HPLC systems create the gradient under high pressure, by mixing the solvents downstream, on the outlet side of the pumps. Such HPLC systems are referred to herein as high-pressure gradient systems. Other HPLC systems create the gradient under low pressure, using a gradient proportioning valve to select from up to four solvents, combining the multiple solvents on the intake side of a single aspirating pump, and changing the proportions of the solvents over time. Such HPLC systems are referred to herein as low-pressure gradient systems.

The choice between a high-pressure and a low-pressure gradient system involves a variety of tradeoffs. For one, high-pressure gradient systems have lesser dwell volumes than low-pressure gradient systems because the solvent mixing occurs after the pumps instead of before the intake side of the pump. On the other hand, low-pressure gradient systems can produce a gradient with just one pump, whereas high-pressure gradient systems generally require one pump for each solvent. Hence, low-pressure-gradient systems are more amenable than high-pressure gradient systems to tertiary and quaternary gradients, and, thus, find use predominantly in such chromatography applications, whereas high-pressure gradient systems generally involve binary gradients.

The output stream of solvent composition produced by low-pressure and high-pressure gradient systems typically has detectable perturbations in a chromatographic baseline, referred to as compositional noise. When a gradient pump outputs a mixture of two fluids—either isocratic or gradient elution—frequencies of operation manifest as oscillations in the compositional output.

A conventional approach for reducing compositional noise is to couple a large-volume mixer to the output of the pump system. This mixer, however, may add an undesirable amount of delay volume to the chromatography system, which can affect the delivery of accurate and reproducible gradients and negatively affect cycle time for a liquid chromatography system. Furthermore, the mixer may actually be ineffective in adequately reducing the compositional noise.

The applicant previously proposed in WO2013/090141, the content of which is herein incorporated in its entirety, a fluid mixer comprising a mixing well, a distribution well, and a plurality of fluidic paths extending from the distribution well to the mixing well. The flow of solvent composition splits at the distribution well into as many streams as fluidic paths. The fluidic paths have different dwell volumes that determine a percentage of the flow of solvent composition carried by each of the fluidic paths. The dwell volumes of the fluidic paths are specifically configured to target the known noise characteristic in the flow of solvent composition. The streams recombine at the mixing well in accordance with the percentages determined by the dwell volumes of the fluidic paths to produce an output compositional stream having the noise characteristic attenuated.

Such known fluid mixers, wherein each path has a different dwell volume, may serve to reduce or substantially eliminate compositional noise. However, the different dwell volumes cause differing volumetric flow rates in each fluidic path. Accordingly, the time taken for a fluid to pass through a fluidic path will be different for each fluidic path. This leads to inconsistent channel clearance, which can require additional down time when the solvents are changed.

When 2 or more fluids (e.g. solvents) are mixed, it is generally desirous to achieve a substantially homogenous resulting fluid. However, the density of at least some of the constituent fluids (e.g. solvents) may differ. The fluids may be substantially immiscible.

### SUMMARY

In one aspect, the present invention provides a fluid mixer comprising:

a flow splitter comprising an inlet for receiving a flow of fluid, the flow splitter configured to split the flow of fluid into first and second fluid streams, the second fluid stream having a higher density than the first fluid stream; and

a mixing chamber comprising a first inlet and a second inlet, the second inlet positioned below the first inlet; and a mixing well, wherein the second inlet of the mixing chamber is configured to receive the first fluid stream and the first inlet of the mixing chamber is configured to receive the second fluid stream, to promote mixing of the first and second streams in the mixing well.

In some embodiments, the flow splitter comprises:

a splitter well in fluid communication with the inlet;

a first outlet in fluid communication with the splitter well, for conveying the first stream; and

a second outlet in fluid communication with the splitter well, for conveying the second stream.

In some embodiments, the second outlet is positioned below the first outlet.

In some embodiments, the first outlet and the second outlet are on opposing sides of the splitter well.

In some embodiments, the flow splitter comprises a splitter plate which presents a leading edge to the flow of fluid in use, to create said first stream above the splitter plate and said second stream below the splitter plate.

In some embodiments, the vertical position of the splitter plate is adjustable.

In some embodiments, at least a part of the splitter plate is generally co-planar with the direction of the flow of fluid in use.

In some embodiments, the fluid mixer further comprises:

a first channel having an inlet to receive and convey the first fluid stream towards an outlet of the first channel, the outlet of the first channel in fluid communication with the second inlet of the mixing chamber; and

a second channel having an inlet to receive and convey the second fluid stream towards an outlet of the second channel, the outlet of the second channel in fluid communication with the first inlet of the mixing chamber.

In some embodiments, the length of the first channel is substantially the same as the length of the second channel.

In some embodiments, the volume of the first channel is substantially the same as the volume of the second channel.

In some embodiments, the cross-sectional area of the first channel is substantially the same as the cross-sectional area of the second channel.

In some embodiments, the first and second inlets of the mixing chamber are on opposing sides of the mixing well.

In some embodiments, the axis of the first inlet of the mixing chamber is substantially co-axial with the axis of the second inlet of the mixing chamber, such that the first and second fluid streams are directed substantially towards one another in the mixing well.

In some embodiments, the volume of the first channel is dissimilar to the volume of the second channel.

In some embodiments, each channel comprises a flow restrictor fluidly connected to a conduit, the conduit being downstream of the flow restrictor.

In some embodiments, the length of the conduit of the first channel is substantially equal to the length of the conduit of the second channel.

In some embodiments, the length of the conduit of the first channel is different to the length of the conduit of the second channel.

In some embodiments, the cross-section area of the conduit of the first channel is different to the cross-section area of the conduit of the second channel.

In some embodiments, the flow restrictors are substantially identical.

In some embodiments, the pressure drop across each of the flow restrictors is substantially identical.

In some embodiments, the pressure drop across the flow restrictor of at least one channel is greater than the pressure drop across the conduit of the channel.

In some embodiments, the pressure drop across the flow restrictor of a channel is at least 10 times greater than the pressure drop across the conduit of that channel.

In some embodiments, the channels are configured to have substantially identical volumetric flow rates.

In some embodiments, there is provided a fluid mixer arrangement, comprising a plurality of fluid mixers according to the claims

In some embodiments, the mixing chamber of each fluid mixer comprises an outlet and the plurality of fluid mixers are arranged in series, such that the outlet of the mixing chamber of a first mixer is fluidly connected to the inlet of the flow splitter of a subsequent fluid mixer.

In some embodiments, at least a second fluid mixer is provided in at least one of the fluid streams of a first fluid mixer.

In one aspect, the present invention provides a fluid mixer comprising:

a flow splitter comprising an inlet for receiving a flow of fluid, the flow splitter configured to split the flow of fluid into a plurality of fluid streams;

a plurality of channels, each for conveying a corresponding one of the plurality of streams;

wherein the plurality of channels have dissimilar volumes and a substantially identical pressure drop across the length of each channel; and

a mixing chamber comprising a plurality of inlets, each fluidly connected to a corresponding one of said plurality of channels.

In some embodiments, each channel comprises a flow restrictor fluidly connected to a conduit, the conduit being downstream of the flow restrictor.

In some embodiments, each of the plurality of conduits are of substantially equal length.

In some embodiments, at least some of the plurality of conduits are of different lengths.

In some embodiments, at least some of the plurality of conduits have different cross-sectional areas.

In some embodiments, the plurality of flow restrictors are substantially identical.

In some embodiments, the pressure drop across each of the plurality of flow restrictors is substantially identical.

In some embodiments, the pressure drop across the flow restrictor of a channel is greater than the pressure drop across the conduit of that channel.

In some embodiments, the pressure drop across the flow restrictor of a channel is at least 10 times greater than the pressure drop across the conduit of that channel.

In some embodiments, the plurality of channels are configured to have substantially identical volumetric flow rates.

In some embodiments, the flow splitter is configured to split the flow of fluid into first and second fluid streams, the second fluid stream having a higher density than the first fluid stream; and the mixing chamber comprises a first inlet and a second inlet, the second inlet positioned below the first inlet; and a mixing well, wherein the second inlet of the mixing chamber is configured to receive the first fluid stream and the first inlet of the mixing chamber is configured to receive the second fluid stream, to promote mixing of the first and second streams in the mixing well.

In some embodiments, the flow splitter comprises:

a splitter well in fluid communication with the inlet;

a first outlet in fluid communication with the splitter well, for conveying the first stream; and

a second outlet in fluid communication with the splitter well, for conveying the second stream,

In some embodiments, the second outlet is positioned below the first outlet.

In some embodiments, the first outlet and the second outlet are on opposing sides of the splitter well.

In some embodiments, the flow splitter comprises a splitter plate which presents a leading edge to the flow of fluid in use, to create said first stream above the splitter plate and said second stream below the splitter plate.

In some embodiments, the vertical position of the splitter plate is adjustable.

In some embodiments, at least a part of the splitter plate is generally co-planar with the direction of the flow of fluid in use.

In some embodiments, the fluid mixer further comprises:

a first channel having an inlet to receive and convey a first fluid stream towards an outlet of the first channel, the outlet of the first channel in fluid communication with a second inlet of the mixing chamber; and

a second channel having an inlet to receive and convey a second fluid stream towards an outlet of the second channel, the outlet of the second channel in fluid communication with a first inlet of the mixing chamber.

In some embodiments, the length of the first channel is substantially the same as the length of the second channel.

In some embodiments, the volume of the first channel is substantially the same as the volume of the second channel.

In some embodiments, the cross-sectional area of the first channel is substantially the same as the cross-sectional area of the second channel.

In some embodiments, the first and second inlets of the mixing chamber are on opposing sides of the mixing well.

In some embodiments, the axis of the first inlet of the mixing chamber is substantially co-axial with the axis of the second inlet of the mixing chamber, such that the first and second fluid streams are directed substantially towards one another in the mixing well.

In some embodiments, the present invention provides a fluid mixer arrangement, comprising a plurality of fluid mixers according to the claims.

In some embodiments, the mixing chamber of each fluid mixer comprises an outlet and the plurality of fluid mixers are arranged in series, such that the outlet of the mixing chamber of a first mixer is fluidly connected to the inlet of the flow splitter of a subsequent fluid mixer.

In some embodiments, at least a second fluid mixer is provided in at least one of the fluid streams of a first fluid mixer.

### BRIEF DESCRIPTION OF THE DRAWINGS

Embodiments will now be described, by way of non-limiting example only, with reference to the figures in which:

FIG. 1 schematically illustrates a fluid mixer according to one embodiment described herein;

FIG. 2 schematically illustrates a vertical cross section of the fluid mixer shown in FIG. 1;

FIG. 3 schematically illustrates a flow splitter of a fluid mixer of an embodiment described herein;

FIG. 4 schematically illustrates a mixing chamber of a fluid of an embodiment described herein;

FIG. 5 schematically illustrates another flow splitter of a fluid mixer of an embodiment described herein;

FIG. 6 illustrates a fluid mixer according to another embodiment described herein;

FIG. 7 schematically illustrates a fluid mixer according to another embodiment described herein;

FIG. 8 schematically illustrates a fluid mixer according to another embodiment described herein;

FIG. 9 illustrates a fluid mixer arrangement according to another embodiment described herein;

FIG. 10 illustrates a fluid mixer arrangement according to another embodiment described herein;

FIG. 11 illustrates a fluid mixer arrangement according to another embodiment described herein; and

FIG. 12 illustrates a fluid mixer arrangement according to another embodiment described herein.

### DETAILED DESCRIPTION

As will be understood from the following description, there are, in general, two aspects; (i) a fluid mixer which is able to split a flow of fluid into first and second fluid streams of different density and promote their mixing; and (ii) a fluid mixer comprising a plurality of channels, each of dissimilar volume but having a substantially identical pressure drop across each channel, which preferably ensures a substantially identical volumetric flow rate through each of the channels of the mixer.

Although aspects are initially illustrated and described separately, embodiments can adopt both aspects described herein. In other words, both the primary and secondary aspects are readily compatible with one another, allowing the provision of a fluid mixer which possesses the features of both aspects and offering the associated compound advantages.

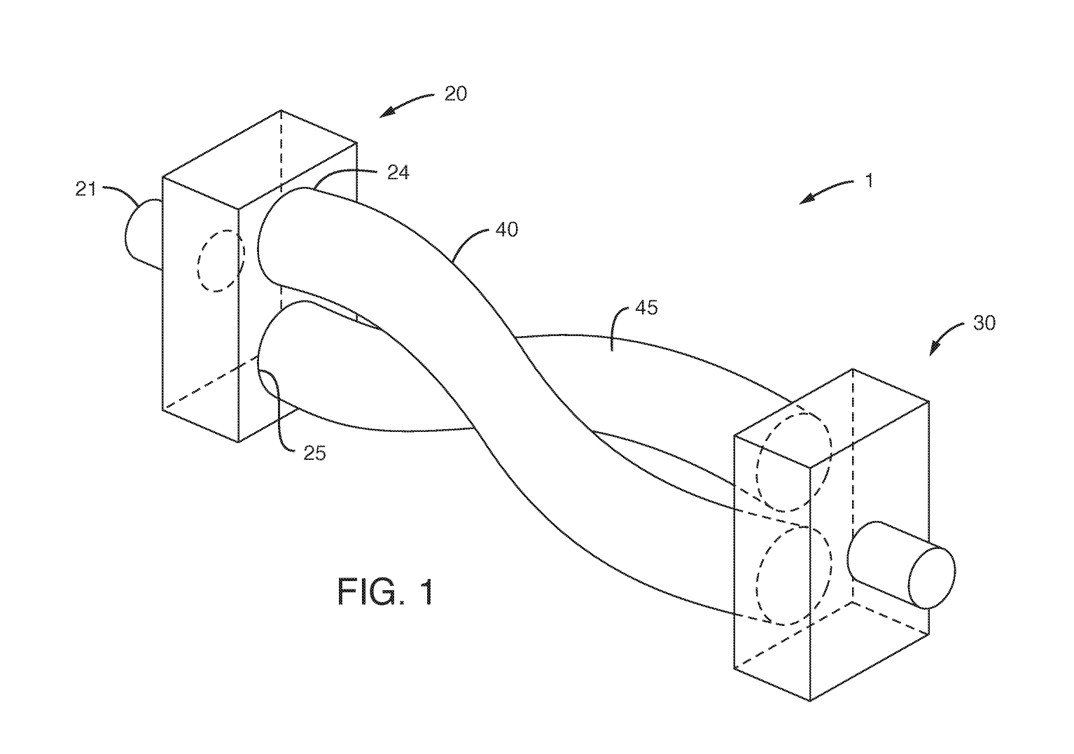

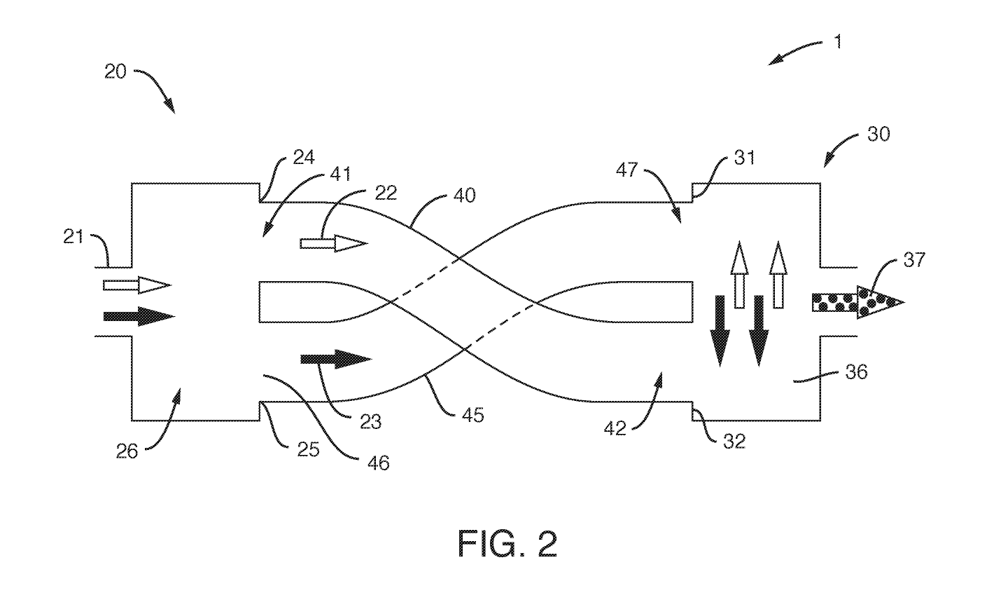

FIGS. 1 and 2 illustrate a fluid mixer (1) comprising a flow splitter (20) and a mixing chamber (30). The flow splitter (20) comprises an inlet (21) for receiving a flow of fluid to be mixed. The flow splitter (20) is configured to split the flow of fluid received at the inlet (21) into a first fluid stream (22) and a second fluid stream (23). The second fluid stream (23) has a higher density than the first fluid stream (22). In the embodiment shown, the flow of fluid received at the inlet (21) of the flow splitter (20) is split, by density, into the first (22) and second (23) fluid streams by virtue of gravity. As shown in the embodiment schematically illustrated in FIGS. 1 and 2, the first fluid stream (22) is vertically above the second fluid stream (23) at the point of leaving the flow splitter.

The composition of the fluid flow is schematically illustrated in FIG. 2 using ‘black’ and ‘white’ arrows. A white arrow, or the white element of an arrow, is used to signify the relatively less dense part of the fluid stream. A black arrow, or the black element of an arrow, is used to signify the relatively more dense part of the fluid stream. Thus, the arrow used to denote the first fluid stream (22) is white; and the arrow used to denote the second fluid stream (23) is black. The arrow used to denote the inlet flow of fluid is both black and white, signifying that it comprises both the first and second fluid streams, albeit not homogeneously mixed. The black and white arrows in the mixing chamber (36) signify the mixing of the first (22) and second (23) streams. The dotted arrow used to signify the outlet stream 37 schematically illustrates its substantially homogeneous nature.

Preferably, the flow splitter (20) comprises a splitter well (26) in fluid communication with the fluid inlet (21). The flow splitter (20) preferably further comprises a first outlet (24) in fluid communication with the splitter well (26), for conveying the first fluid stream (22) away from the splitter well (26). The flow splitter (20) preferably further comprises a second outlet (25) in fluid communication with the splitter well (26), for conveying the second fluid stream (23). Preferably, the first outlet (24) is vertically above the second outlet (25). FIG. 2 is a cross-sectional side view of the arrangement shown in FIG. 1. It is not essential that the first outlet (24) is exactly vertically above the second outlet (25). Preferably, the first outlet (24) is at least higher than the second outlet (25), such that, due to gravity, the second fluid stream (23) passing into the second outlet (25) will likely be more dense than the first fluid stream (22) passing into the first outlet (24).

An alternative flow splitter (120), is schematically illustrated in FIG. 3. As with the flow splitter (20) illustrated in FIGS. 1 and 2, the flow splitter (120) of FIG. 3 comprises an inlet (21). The flow splitter (120) further comprises a first outlet (124) and a second outlet (125). Rather than being positioned substantially next to one another, extending perpendicularly from the same plane, as in the embodiment illustrated in FIGS. 1 and 2, the first outlet (124) and second outlet (125) of the flow splitter (120) shown in FIG. 3 are arranged on opposing sides of the splitter well (126). At the point of connection to the flow splitter (120), the first outlet (124) and the second outlet (125) are directed away from one another. The arrangement shown in FIG. 3 may provide for more effective splitting of the fluid flow in the fluid inlet (21).

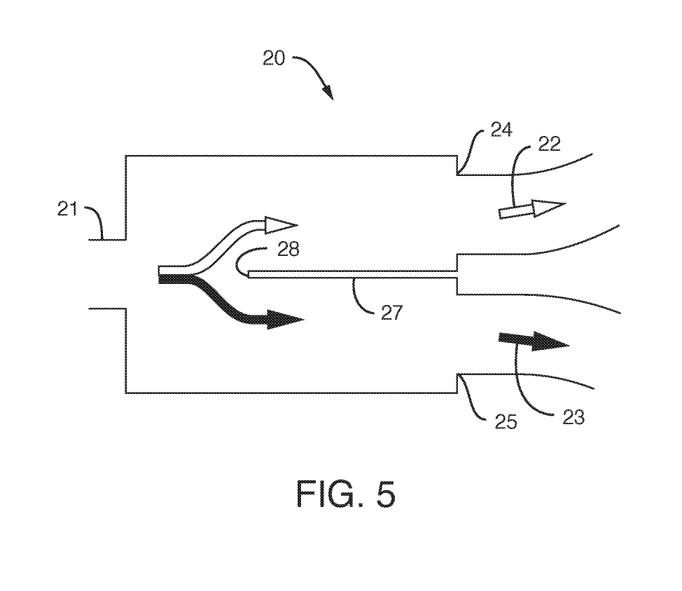

FIG. 5 schematically illustrates another flow splitter (20) of a mixer. The flow splitter (20) illustrated in FIG. 5 generally corresponds to the flow splitter (20) shown in FIG. 2. However, the flow splitter (20) in FIG. 5 additionally comprises a splitter plate (27) which presents a leading edge (28) to the flow of fluid in use, to create a second fluid stream (23) having a lower density than a first fluid stream (22). Preferably, the axial length of the body of the flow splitter (20), i.e. the distance between the inlet (21) and the first (24) and second (25) outlets is configured such that the incoming fluid is able to be sufficiently passively separated, due to gravity, into a lower, dense, part and an upper, less dense, part. Preferably, the vertical position of the splitter plate (27) and/or the vertical position of the leading edge (28) of the splitter plate (27) is adjustable. In the case of the inlet fluid stream comprising two immiscible fluids. The position of the leading edge (28) and/or the splitter plate (27) may be configured so as to substantially align with the fluid boundary (meniscus) between the two immiscible fluids.

Preferably, at least a part of the splitter plate (27), preferably the part of the splitter plate (27) adjacent the leading edge (28), is generally coplanar with the direction of flow of the inlet fluid in use.

Returning to FIGS. 1 and 2, the mixing chamber (30) comprises a first fluid inlet (31) and a second fluid inlet (32). The second fluid inlet (32) is positioned vertically below the first inlet (31). Preferably, the second fluid inlet (32) is at least lower than the first inlet (31). The mixing chamber (30) further comprises a mixing well (36). The second inlet (32) of the mixing chamber (30) is configured to receive the first fluid stream (22). The first inlet (31) of the mixing chamber (30) is configured to receive the second fluid stream (23). The first (22) and second (23) fluid streams arrive at the mixing chamber (30) in an orientation which is inverted from the orientation in which they left the flow splitter (20). In other words, the first (22) and second (23) fluid streams are “flipped”. The benefit of this arrangement is that it promotes more effective mixing of the first (22) and second (23) fluid streams in the mixing well (36) of the mixing chamber (30). The fluid output (37) of the fluid mixer (1) is preferably more homogenous than that received at the inlet (21) of the flow splitter (20) of the fluid mixer (1).

The fluid mixer (1) preferably further comprises a first channel (40) and a second channel (45). The first channel (40) has an inlet (41) configured to receive and convey the first fluid stream (22) towards an outlet (42) of the first channel (40). The inlet (41) of the first channel (40) is fluidly connected to the first outlet (24) of the flow splitter (20). The outlet (42) of the first channel (40) is in fluid communication with the second inlet (32) of the mixing chamber (30).

The fluid mixer (1) further comprises a second channel (45) having an inlet (46) which is configured to receive and convey the second fluid stream (23) towards an outlet (47) of the second channel (45). The inlet (46) of the second channel (45) is in fluid communication with the second outlet (25) of the flow splitter (20). The outlet (47) of the second channel (45) is in fluid communication with the first inlet (31) of the mixing chamber (30). The flow stream received at the inlet (21) is split vertically and then later rejoined in a reversed orientation. As a result, a less dense fluid stream is introduced into a more dense fluid stream from below and gravity causes the two fluid streams to mix—i.e. the more dense fluid stream flows ‘through’ the less dense fluid stream, causing mixing.

Preferably, the length of the first channel (40) is substantially the same as the length of the second channel (45). Preferably, the volume of the first channel (40) is substantially the same as the volume of the second channel (45). Preferably, the cross sectional area of the first channel (40) is substantially the same as the cross sectional area of the second channel (45).

Although in the embodiment schematically illustrated in FIGS. 1 and 2 the first (40) and second (45) channels appear to be of the same length, cross-section and volume, this is not essential. In another embodiment (described later) the volume of the first channel (40) may be dissimilar to the volume of the second channel (45).

In the embodiment schematically illustrated in FIGS. 1 and 2, the mixing chamber (30) is similar in form to the flow splitter (20). That is to say that the first (31) and second (32) inlets of the mixing chamber (30) are on the same side face of the mixing well (36), such that the respective axes of the first (31) and second (32) inlets are parallel to one another.

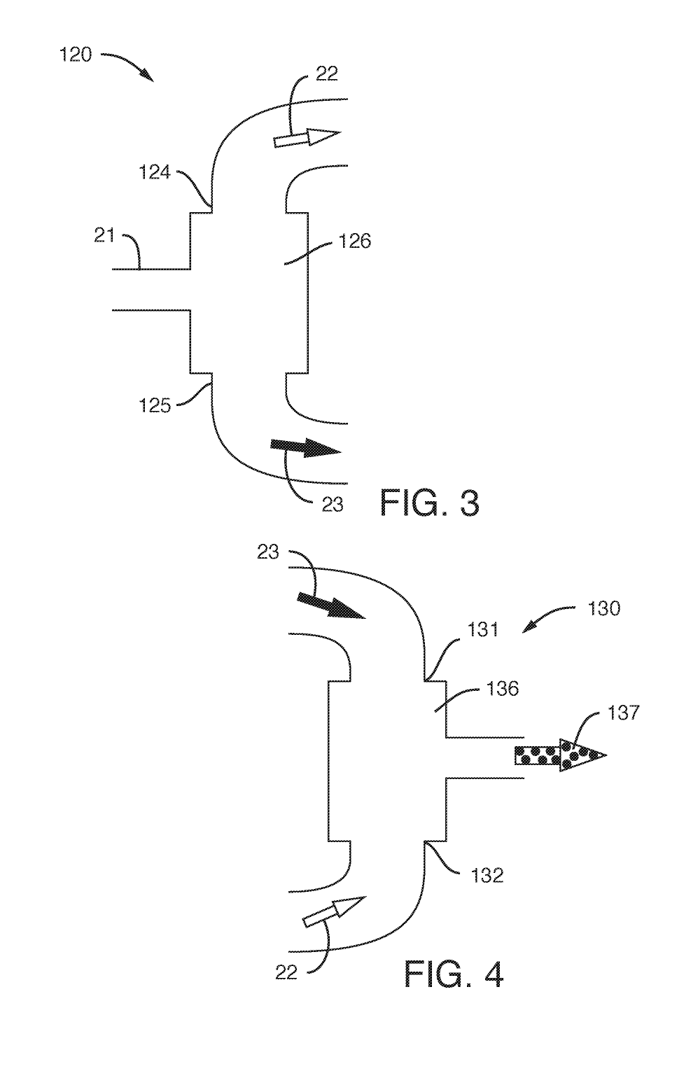

In an alternative mixing chamber (130), schematically illustrated in FIG. 4, the first inlet (131) and the second inlet (132) of the mixing chamber (130) are provided on opposing sides of the mixing well (136). Consequently, the axis of the first inlet (131) of the mixing chamber (130) is substantially co-axial with the axis of the second inlet (132) of the mixing chamber (130), such that the first (22) and second (23) fluid streams are directed substantially towards one another in the mixing well (136), thereby aiding mixing. The relative velocity of the colliding first (22) and second (23) fluid streams will be the sum of the velocity of each stream (22, 23). The mixing well (36, 136) of the mixing chamber (30, 130) may comprise other features which aid the mixing of the first (22) and second (23) fluid streams. Such features may comprise components (not shown) to increase the turbulence of the fluid in the mixing well (36, 136). In some embodiments there may be a mechanical agitator (not shown) in the mixing well (36, 136).

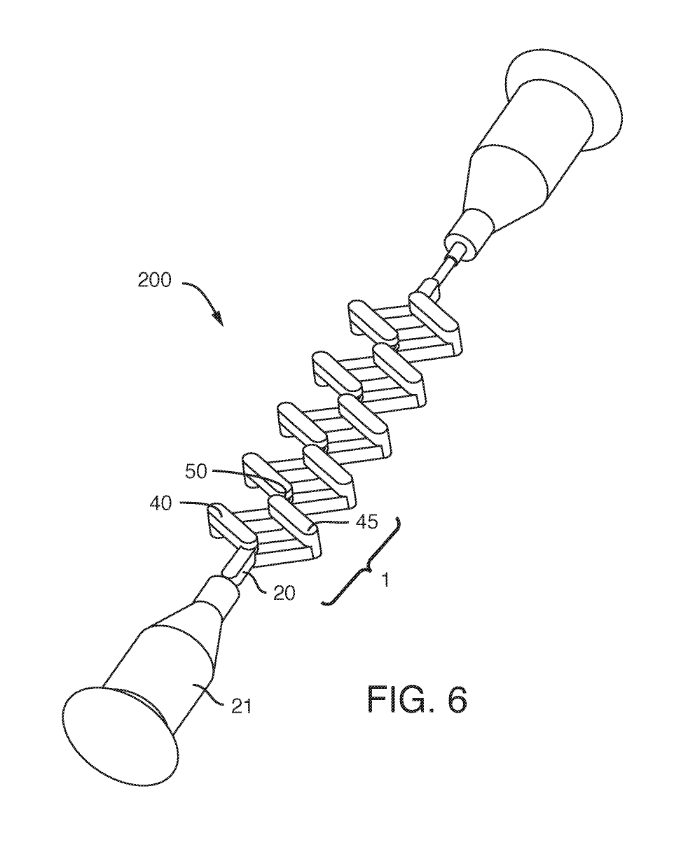

FIG. 6 illustrates a fluid mixer arrangement (200). The fluid mixer arrangement (200) comprises a plurality of fluid mixers (1) according to an embodiment described herein. In the fluid mixer arrangement (200) shown in FIG. 6, there are five fluid mixers (1) connected together in series. By connecting a plurality of fluid mixers (1) in series, the mixing, and thus homogenisation, of the fluid is preferably further improved.

In some embodiments, a fluid mixer is provided by forming cavities within a block of material, to define the flow splitter, mixing chamber and channels etc. Consequently, the figures illustrate a ‘negative’ of those cavities. This is why the inlet 21 illustrated in FIG. 6 apparently comprises a solid article—it is the ‘negative’ of the inlet 21. Given the complex nature of the components of the invention, it will be appreciated that this method of illustrating the invention is clearer than providing multiple cross-sectional views and cut-through views of a block containing cavities which form the various features.

As illustrated, the first fluid mixer (1) in the series of the fluid mixer arrangement (200) shown in FIG. 6 comprises a fluid inlet (21) which is in fluid communication with a flow splitter (20). The flow splitter (20) splits the flow of fluid into first (22) and second (23) fluid streams, which are conveyed by first (40) and second (45) channels.

The first (40) and second (45) channels illustrated in FIG. 6 are of different physical form to those illustrated schematically in FIGS. 1 and 2. This is because the arrangement (200) shown in FIG. 6 is the negative of the channels which are formed in a microfluidic device. Preferably, the microfluidic device is formed by bonding multiple layers of material to one another, each layer comprising groove/indentations which are aligned together to form channels therein. The exact physical form of the first (40) and second (45) channels is not of significance. It is to be noted from FIG. 6 that the outlet (42) of the first channel (40) is positioned vertically below the outlet (47) of the second channel (45).

In-between the first and second fluid mixers (1) of the arrangement (200) shown in FIG. 6, there is preferably a combined mixing chamber and fluid splitter (50) downstream of the first fluid mixer (1), which serves to promote mixing of the first and second fluid streams (22), (23) received from the first mixer and to subsequently split the flow of fluid into first (22) and second (23) fluid streams for the second fluid mixer (1). The use of a fluid mixer arrangement (200) incorporating multiple stages of fluid mixers preferably increases turbulence and increases the homogenisation of the mixed fluid.

As well as connecting a plurality of fluid mixers in series, as illustrated in FIG. 6, a secondary fluid mixer may be provided within one of the fluid streams of a first fluid mixer. That is to say, between passing from the flow splitter (20) to the mixing chamber (30), one of the first (22) and second (23) fluid streams may be passed through a secondary fluid mixer which further splits that stream into two sub-streams and promotes mixing of the fluid in that stream. Multiple fluid mixers may be consecutively “nested” within a larger fluid mixer arrangement.

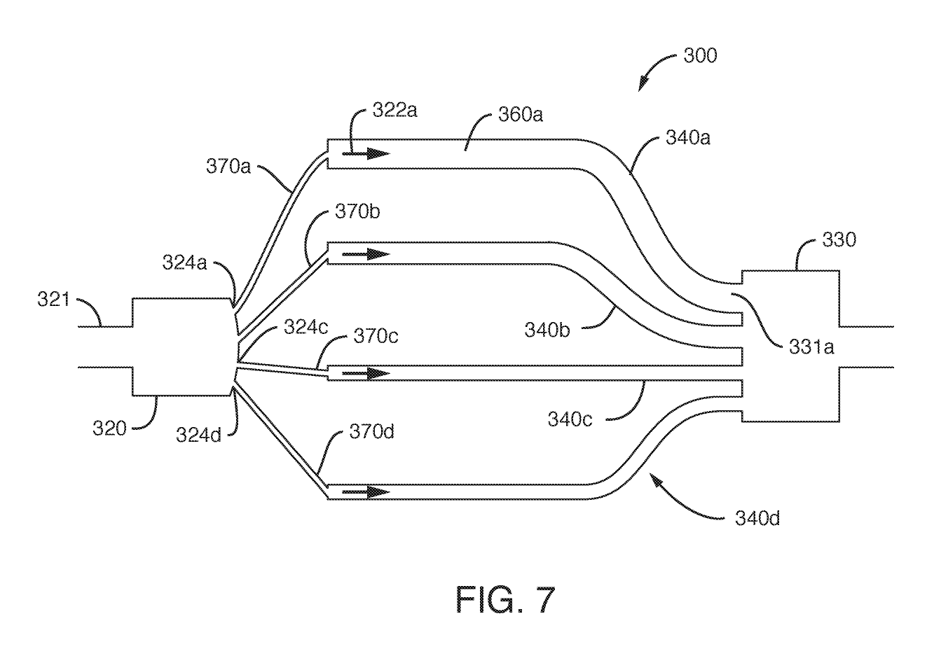

FIG. 7 schematically illustrates a fluid mixer (300) embodying a second aspect.

The fluid mixer (300) comprises a flow splitter (320) comprising an inlet (321) for receiving a flow of fluid. The flow splitter (320) is configured to split the flow of fluid into a plurality of fluid streams (322a, 322b, 322c, 322d). Preferably, the flow splitter (320) comprises a plurality of outlets (324a, 324b, 324c, 324d). Despite the apparent similarity of the general configuration of the arrangements in FIGS. 2 and 7, FIG. 7 schematically illustrates the fluid mixer (300) in plan view (as compared to a side view). Therefore, the outlets (324a-d) are in the same horizontal plane. However, this is not essential.

The fluid mixer (300) further comprises a plurality of channels (340a, 340b, 340c, 340d), each for conveying a corresponding one of the plurality of streams (322a-d).

Each of the plurality of channels (340a-d) have dissimilar internal volumes but a substantially identical pressure drop across the length of each channel (340a-d).

The fluid mixer (300) further comprises a mixing chamber (330) comprising a plurality of inlets (331a, 331b, 331c, 331d), each fluidly connected to a corresponding one of the plurality of channels (340a-d). Thus, channel (340a) is connected to inlet (331a), channel (340b) is connected to inlet (331b) etc.

Each channel (340a-d) preferably comprises a flow restrictor (370a-370d) connected to a conduit (360a-360d), the conduit (360) being downstream of the flow restrictor (370a-370d).

In the embodiment illustrated in FIG. 7, each of the plurality of conduits (360a-d) are of substantially equal length.

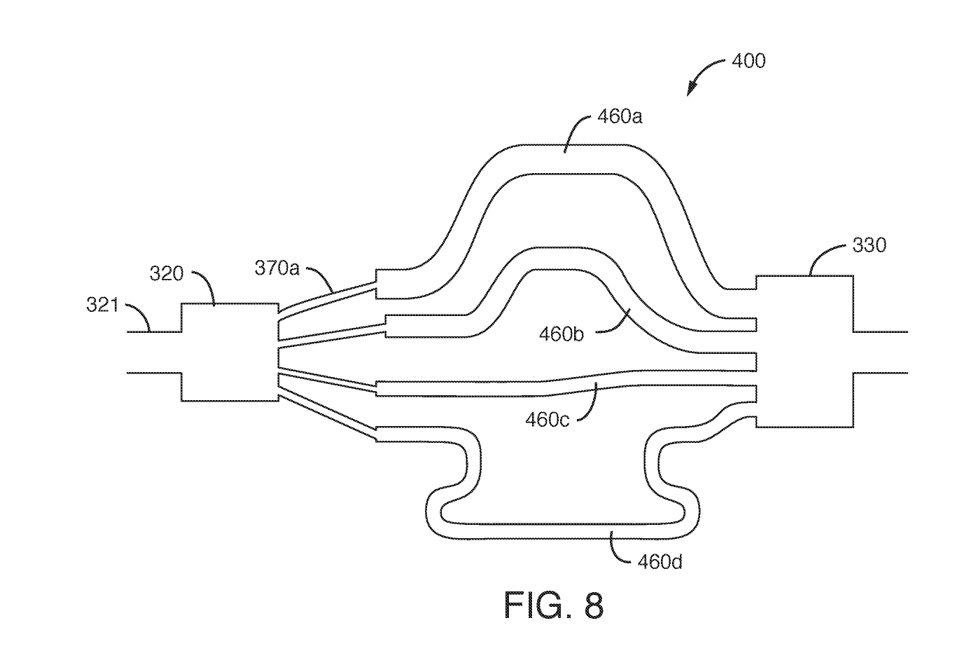

In some embodiments, some or all of the conduits are of different lengths. In another embodiment, shown in FIG. 8, the conduits (460a-d) are all of different lengths.

In one embodiment, illustrated in FIG. 7, at least some of the plurality of conduits (360a-d) have different cross-sectional areas.

It will be appreciated that in order to have channels of dissimilar volumes, there are at least two ways of achieving this:

a) identical length but different cross-sectional area; or

b) identical cross-sectional area but different lengths.

Rather than being mutually exclusive, both ways of achieving dissimilar volumes may be adopted. Both the length and cross-sectional area of a channel may be different to both the length and cross-sectional area of another channel. The cross-sectional area of a channel may be uniform or non-uniform along its length.

Preferably, the plurality of flow restrictors (370a-d) are substantially identical such that the pressure drop across each of the plurality of flow restrictors (370a-d) is substantially identical.

Preferably, the pressure drop across a flow restrictor (370) is greater than the pressure drop across the conduit (360) of that channel (340). Preferably, the pressure drop across the flow restrictor (370) is at least 10 times greater than the pressure drop across the conduit (360) of that channel (340).

Preferably, the plurality of channels (340a-d) are configured to have substantially identical volumetric flow rates therethrough. A benefit of such an arrangement is that it suppresses, or substantially cancels, volumetric noise frequencies in the fluid stream without having differential volumetric flow rates through each of the channels which would otherwise create inconsistent channel clearance upon changing a solvent. Preferably, as a section of the flow of fluid at the inlet (321) of the flow splitter (320) is split into a plurality of fluid streams, those component parts of the inlet fluid stream will recombine at the mixing chamber (330) at substantially the same time.

When the conduits (360a-d) are of different lengths but substantially identical cross sections, the pressure drop across each of the conduits (360a-d) may differ. However, the pressure drop across a fluid restrictor (370a-d) is preferably substantially higher than the pressure drop across a corresponding conduit (360a-d). Consequently, the pressure drop across the channels (340a-d) as a whole will be substantially the same.

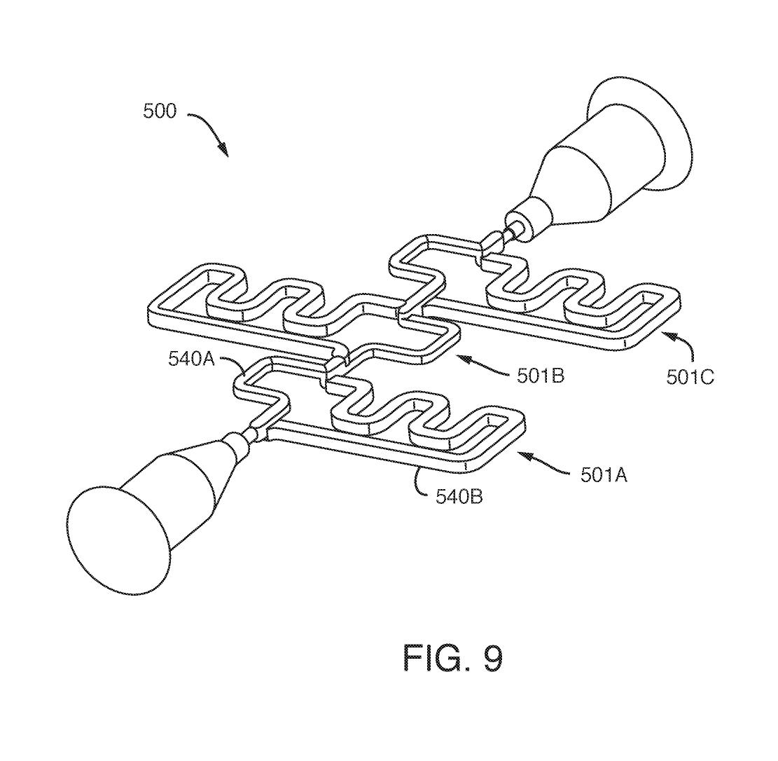

In the embodiments schematically illustrated in FIGS. 7 and 8 there are four channels (340a-d), but this is not essential. There may be more or fewer than four channels. There may be two channels. As with the fluid mixer (1) illustrated in FIGS. 1 to 6, a plurality of fluid mixers (300, 400) may be provided in a fluid mixer arrangement. FIG. 9 illustrates a fluid mixer arrangement (500) comprising three fluid mixers (501a), (501b), (501c), connected in series. Accordingly, the arrangement (500) shown in FIG. 9 generally corresponds to the arrangement (200) illustrated in FIG. 6, by providing a series of interconnected fluid mixers.

In the embodiment illustrated in FIG. 9, each of the fluid mixers (501a-c) comprises two channels (540a-b).

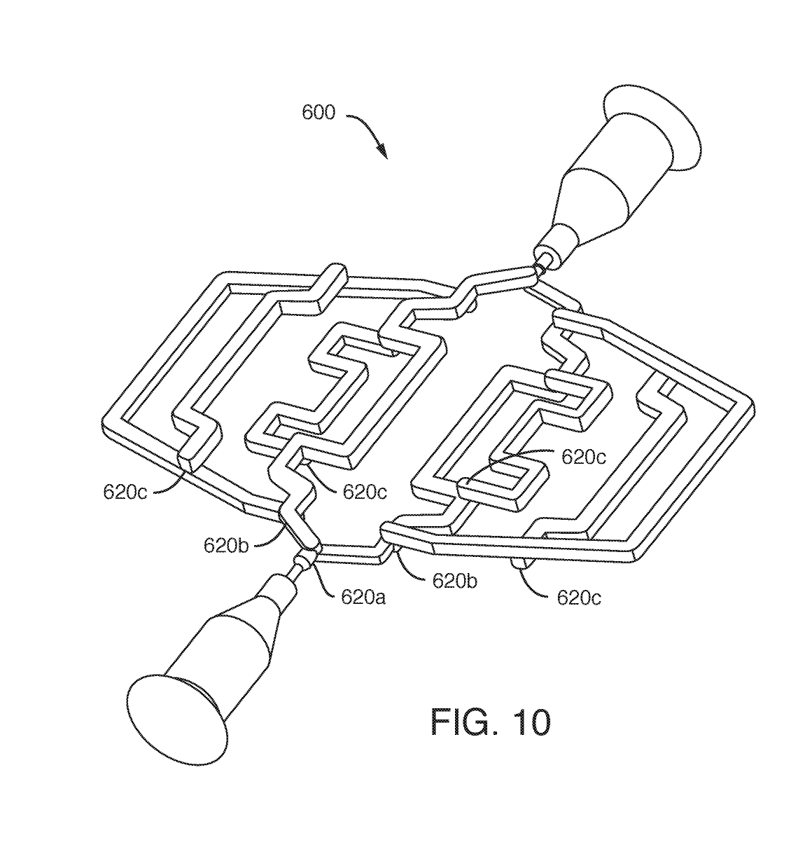

FIG. 10 illustrates another fluid mixer arrangement (600), which comprises 8 channels (640).

In the embodiment shown in FIG. 10, rather than providing a single flow splitter, such as the flow splitter (320) illustrated in FIGS. 7 and 8, having multiple (e.g. three or more) outlets (324a-d), the mixer arrangement (600) illustrated in FIG. 10 comprises a series of flow splitters (620a-c), which each split the incoming fluid flow into two fluid streams. Each of those fluid streams is then further split by a second stage splitter into two sub-streams, which are then split by a third stage of flow splitter. With reference to FIG. 10, each of the two fluid streams exiting the first stage flow splitter (620a) communicate with a respective second stage flow splitter (620b). Each of the fluid streams from each of those second stage flow splitters (620b) are then fed to a third stage flow splitter (620c). There is a single first stage flow splitter (620a), two second stage flow splitters (620b) and four second stage flow splitters (620c). This allows for the fluid flow ultimately to be split into eight separate channels (640), as illustrated in FIG. 10.

FIG. 6 illustrates a mixer arrangement comprising a plurality of the same type of fluid mixer (embodying the first aspect). Likewise, FIG. 9 illustrates a mixer arrangement comprising a plurality of mixers embodying the second aspect of the invention. It is, of course, possible to provide a mixer arrangement comprising different fluid mixers connected in series. For example, a fluid mixer as illustrated in FIGS. 1 and 2 may be provided upstream of the fluid mixer illustrated in FIG. 7. Any combination of any of the mixers illustrated, described and/or envisaged herein may be connected together to form a mixer arrangement.

As noted above, both the primary and second aspects can be combined in a single mixer embodiment.

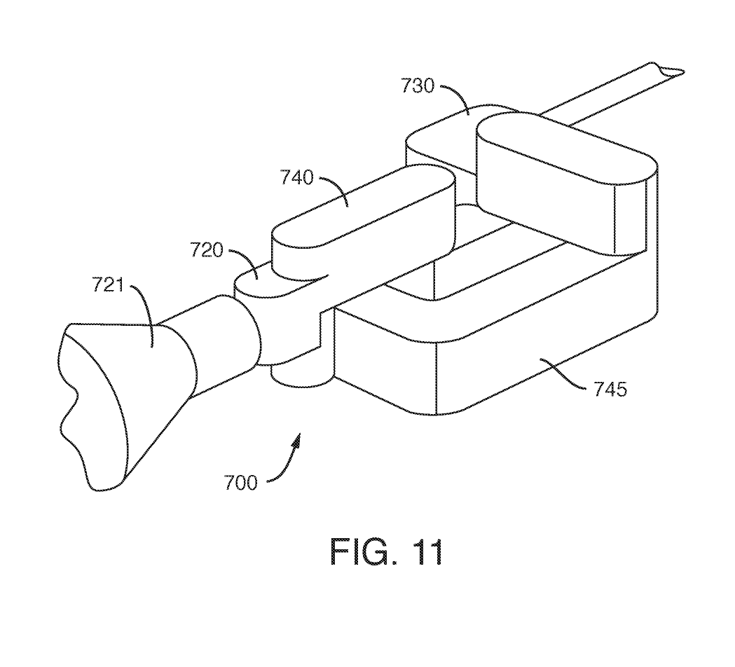

FIG. 11 illustrates a fluid mixer (700) comprising a flow splitter (720) comprising an inlet (721) for receiving a flow of fluid. The flow splitter (720) is configured to split the flow of fluid into first and second fluid streams. The second fluid stream has a higher density than the first fluid stream. It is to be noted from FIG. 11 that the flow splitter (720) has an arrangement corresponding to that of the flow splitter (120) illustrated in FIG. 3—i.e. outlets on opposing sides of the chamber.

The fluid mixer (700) of FIG. 11 further comprises a mixing chamber (730) comprising a first inlet and a second inlet (partially obscured in FIG. 11). The fluid mixer (700) further comprises a first channel (740) which conveys the first fluid stream from the flow splitter (720) to the second inlet of the mixing chamber (730). The fluid mixer (700) further comprises a second channel (745) configured to receive and convey the second fluid stream towards the first inlet of the mixing chamber (730). The first inlet of the mixing chamber (730) is arranged vertically above the second inlet of the mixing chamber (730). Accordingly, as with the embodiments illustrated and described with reference to FIGS. 1 to 6, the first and second fluid streams are inverted, promoting mixing as they recombine in the mixing chamber (730).

Furthermore, the first channel (740) has a different length and cross section to the second channel (745). Accordingly, the channels (740, 745) have dissimilar volumes. Preferably, they have substantially identical pressure drops across the length of each of the first (740) and second (745) channels.

A benefit of an embodiment, such as the fluid mixer (700) illustrated in FIG. 11, combining both the primary and secondary aspects is that it provides a fluid mixer which has advantages of each aspect of the invention. Specifically, the inversion of the split fluid stream promotes homogenisation of the fluid, whereas the use of channels with dissimilar volumes but equal pressure drops serves to reduce, or substantially cancel, volumetric noise frequencies.

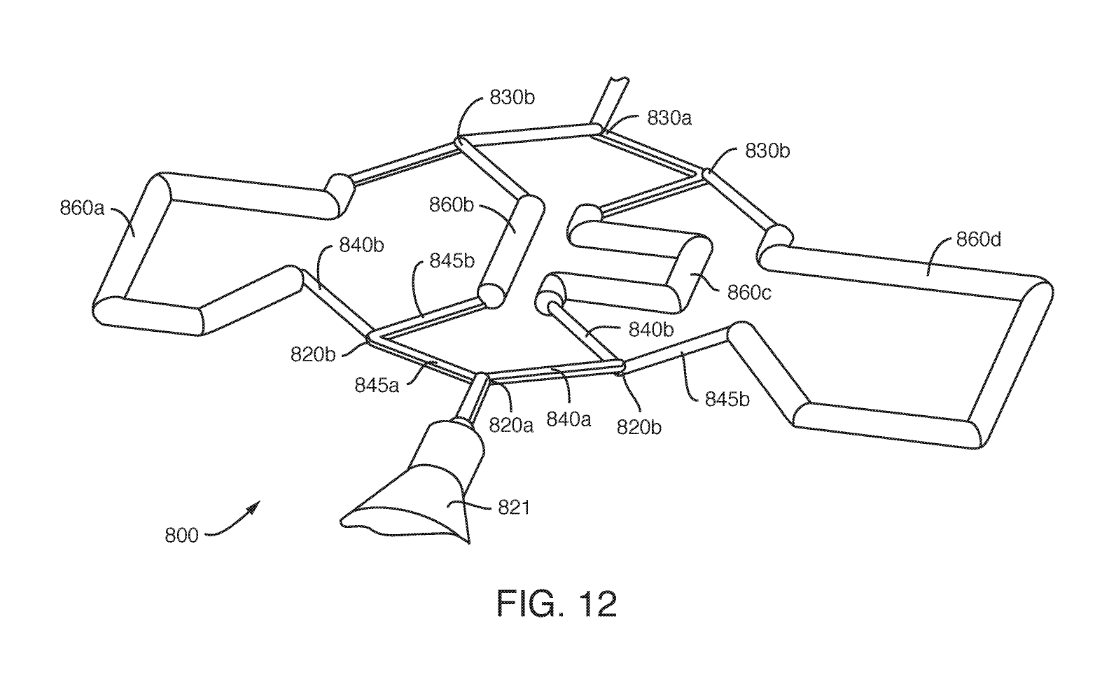

FIG. 12 shows another fluid mixer (800) incorporating both the primary and secondary aspects. In a similar fashion to the fluid mixer (600) shown in FIG. 10, the fluid mixer (800) shown in FIG. 12 comprises four parallel channels which are all of dissimilar volumes but substantially identical pressure drops thereacross.

In the mixer arrangement shown in FIG. 12, each parallel channel (840) comprises a conduit (860) and a fluid restrictor (not labelled). The fluid mixer (800) shown in FIG. 12 comprises two stages of flow splitter (820). The initial fluid stream from the fluid inlet (821) is split into two fluid streams (of different densities) and conveyed via a first channel (840a) and a second channel (845a). Each of those channels (840a), (845b) then communicates with a second stage flow splitter (820b) which further splits the fluid flow into two further channels (840b), (845b). The second stage flow splitters (820b) also split the fluid into first and second fluid streams of different densities. The fluid then passes through the four conduits (860a-d). It is to be noted that the network of channels between the fluid inlet (821) and the fluid conduit (860a)-(860d) create four pathways which are substantially of the same length. Preferably, the pathways create a fluid restrictor, each having a substantially identical pressure drop thereacross. Downstream of the fluid conduits (860a)-(860d), the fluid streams recombine in a two stage mixing chamber (830) arrangement.

The fluid mixers of FIGS. 11 and 12 conveniently incorporate, harmoniously and synergistically, each of the primary and secondary aspects. A benefit of providing a single mixer incorporating both the first and second aspects of the invention, rather than two separate mixers connected in series, is that the dwell volume is kept to a minimum, allowing a decrease in cycle time.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1. A fluid mixer comprising:
a flow splitter comprising an inlet for receiving a flow of fluid, the flow splitter configured to split the flow of fluid into a plurality of fluid streams;
a plurality of channels, each one of the channels for conveying a corresponding one of the fluid streams, wherein the plurality of channels have dissimilar volumes and a substantially identical pressure drop across the length of each channel; and
a mixing chamber comprising a plurality of inlets, each of the inlets fluidly connected to a corresponding one of the channels.

2. A fluid mixer according to claim 1, wherein each channel comprises a flow restrictor fluidly connected to a conduit, the conduit being downstream of the flow restrictor.

3. A fluid mixer according to claim 2, wherein each of the conduits are of substantially equal length.

4. A fluid mixer according to claim 2, wherein at least some of the conduits are of different lengths.

5. A fluid mixer according to claim 1, wherein at least some of the conduits have different cross-sectional areas.

6. A fluid mixer according to claim 2, wherein the flow restrictors are substantially identical.

7. A fluid mixer according to claim 6 wherein the pressure drop across each of the flow restrictors is substantially identical.

8. A fluid mixer according to claim 2, wherein the pressure drop across the flow restrictor of a channel is greater than the pressure drop across the conduit of that channel.

9. A fluid mixer according to claim 8, wherein the pressure drop across the flow restrictor of a channel is at least ten times greater than the pressure drop across the conduit of that channel.

10. A fluid mixer according to claim 1, wherein the channels are configured to have substantially identical volumetric flow rates.

11. A fluid mixer according to claim 1, wherein the flow splitter is configured to split the flow of fluid into first and second fluid streams, the second fluid stream having a higher density than the first fluid stream, and wherein the mixing chamber comprises a first inlet and a second inlet, the second inlet positioned below the first inlet, and a mixing well, wherein the second inlet of the mixing chamber is configured to receive the first fluid stream and the first inlet of the mixing chamber is configured to receive the second fluid stream, to promote mixing of the first and second streams in the mixing well.

12. A fluid mixer according to claim 11, wherein the flow splitter comprises:
a splitter well in fluid communication with the inlet;
a first outlet in fluid communication with the splitter well, for conveying the first stream; and
a second outlet in fluid communication with the splitter well, for conveying the second stream.

13. A fluid mixer according to claim 12, wherein the second outlet is positioned below the first outlet.

14. A fluid mixer according to claim 12, wherein the first outlet and the second outlet are on opposing sides of the splitter well.

15. A fluid mixer according to claim 11, wherein the flow splitter comprises a splitter plate which presents a leading edge to the flow of fluid in use, to create said first stream above the splitter plate and said second stream below the splitter plate.

16. A fluid mixer according to claim 15, wherein the vertical position of the splitter plate is adjustable.

17. A fluid mixer according to claim 15, wherein at least a part of the splitter plate is generally co-planar with the direction of the flow of fluid in use.

18. A fluid mixer according to claim 1, comprising:
a first channel having an inlet to receive and convey a first fluid stream towards an outlet of the first channel, the outlet of the first channel in fluid communication with a second inlet of the mixing chamber; and
a second channel having an inlet to receive and convey a second fluid stream towards an outlet of the second channel, the outlet of the second channel in fluid communication with a first inlet of the mixing chamber.

19. A fluid mixer according to claim 18, wherein the length of the first channel is substantially the same as the length of the second channel.

20. A fluid mixer according to claim 18, wherein the volume of the first channel is substantially the same as the volume of the second channel.

21. A fluid mixer according to claim 18, wherein the cross-sectional area of the first channel is substantially the same as the cross-sectional area of the second channel.

22. A fluid mixer according to claim 11, wherein the first and second inlets of the mixing chamber are on opposing sides of the mixing well.

23. A fluid mixer according to claim 22, wherein the axis of the first inlet of the mixing chamber is substantially co-axial with the axis of the second inlet of the mixing chamber, such that the first and second fluid streams are directed substantially towards one another in the mixing well.

24. A fluid mixer arrangement, comprising a plurality of fluid mixers according to claim 1.

25. A fluid mixer arrangement according to claim 24, wherein the mixing chamber of each fluid mixer comprises an outlet and the plurality of fluid mixers are arranged in series, such that the outlet of the mixing chamber of a first mixer is fluidly connected to the inlet of the flow splitter of a subsequent fluid mixer.

26. A fluid mixer arrangement according to claim 24, wherein at least a second fluid mixer is provided in at least one of the fluid streams of a first fluid mixer.
